(19) United States
(12) Patent Application Publication
(10) Pub. No.: US 2024/0286186 A1
(43) Pub. Date: Aug. 29, 2024

(54) COMPOUND PROFILING FORGING METHOD FOR LARGE WIND TURBINE MAIN SHAFT

(71) Applicant: Zenkung Heavy Industry (Jiangsu) Co., Ltd, Jiangyin (CN)

(72) Inventors: Zhenwei Yan, Jiangyin (CN); Wenyin Peng, Jiangyin (CN); Kang Yue, Jiangyin (CN); Jie He, Jiangyin (CN)

(21) Appl. No.: 18/582,624

(22) Filed: Feb. 20, 2024

(30) Foreign Application Priority Data
Feb. 23, 2023 (CN) 202310154159.8

(51) Int. Cl. B21J 5/08; B21J 1/06; B21J 5/10

(52) U.S. Cl. CPC B21J 5/08; B21J 1/06; B21J 5/10

(57) ABSTRACT

A compound profiling forging method for a wind turbine main shaft includes: making a billet into a flat square billet, returning the billet into a furnace and holding a temperature at 1250° C.; preliminary punching, including: upsetting and drawing out the billet twice, and carrying out punching and rolling; preparing a piercing punch and a punching block, putting the billet in the punching block, putting the piercing punch into a hole of the billet, and operating an oil press to press the piercing punch to be flush with the billet; heating the billet, holding a temperature at 850° C., putting the billet in the punching block, preparing a female die and a punch, and inserting the piercing punch into an inner hole of the billet to carry out flange upsetting; and drawing out the shaft body of the billet in sequence, with a forging temperature range of 850-1250° C.

### CROSS REFERENCE TO RELATED APPLICATIONS

The present application claims the benefit of Chinese Patent Application No. 202310154159.8 filed on Feb. 23, 2023, the contents of which are incorporated herein by reference in their entirety.

### TECHNICAL FIELD

The present invention relates to the field of wind power equipment main shaft manufacturing, and particularly relates to a compound profiling forging method for a large wind turbine main shaft.

### BACKGROUND

With the rapid development and maturity of the wind power industry in our country, the single-unit generating power of megawatt (MW)-level wind turbine main shafts is gradually developing to a higher level. At present, large-size main shafts of above 9 MW are mostly castings. Despite their light weights, the development and application of the main shafts within a size range of 6-10 MW have been restricted to a great extent because of disadvantages of forging products such as low mechanical properties, more casting defects and a higher tower collapse rate after installation. Because comprehensive mechanical properties of forging pieces are much better than those of castings, with the continuous improvement of forging technology and continuous upgrading of forging and pressing equipment, there is an urgent need for main shaft forgings to substitute for main shaft castings.

Particularly, various types of main shafts of above 6 MW have appeared in recent years. As shown in FIG. 1, such main shafts have large flange diameters, and steps of inner holes are mostly in the shapes of irregular curves. Like a traditional forging billet structural body shown in FIG. 2, three required steps need to be machined in an inner hole of a billet, and because of irregular curve outlines, the steps are difficult to process.

The billet forming process has the following problems:
1. a traditional forging production method mainly comprises working steps of upsetting, punching and drawing out, because of special-shaped inner holes of billets, problems such as eccentricity of the inner holes in different sizes during the transition and deformation of the forging process and folding of the inner holes cannot be avoided by a conventional hollow mandrel drawing-out forming method, huge investment is needed for raw materials for products with the special-shaped inner holes, a longer time will be taken in the subsequent deep hole machining process, and an overall production schedule will be badly delayed; and
2. when heating and forging large-size thin-walled hollow main shafts by free forging, it is not easy to eliminate composition segregation of raw materials and a forging temperature difference between the interior and an outer surface of the billet, and the phenomena such as coarse grains and agglomeration of non-metallic inclusions may occur easily, which have very significant effects on mechanical properties of the products.

### SUMMARY OF THE INVENTION

According to the above defects in the prior art, the present invention aims to provide a compound profiling forging method for a large wind turbine main shaft, which has the advantages that inner holes of main shafts are machined by a profiling forging near-net-shape process, special piercing punches and profiling mandrels in appropriate sizes and shapes are designed through finite element calculations, thereby reducing the overall deformation of billets, reasonably setting holding temperatures and holding time, homogenizing local compositions of the billets and improving performance.

The aforementioned technical purpose of the present invention is realized through the following technical solution:
a compound profiling forging method for a large wind turbine main shaft, comprising the following steps:
step S1, carrying out first heat-up upsetting on a billet to make the billet into a flat square billet, returning the billet into a furnace and holding a temperature at 1250° C.;
step S2, preliminary stamping, comprising the following working steps:
working step 1: upsetting and drawing out the billet twice, and carrying out punching and rolling on the billet; and
working step 2: preparing a piercing punch and a punching block, putting the billet in the punching block, putting the piercing punch into a hole of the billet, and operating an oil press to press the piercing punch to be flush with the billet, so that the punching is completed, wherein the piercing punch comprises a forming part I and a forming part II, the forming part II is provided below the forming part I, a radius of the piercing punch gradually decreases along a center axis from top to bottom, and a curved surface transits from the first forming part I to the forming part II;
step S3, spinning forming:
heating the billet, holding a temperature at 850° C., putting the billet in the punching block, preparing a female die and the piercing punch, mounting the female die on the oil press, inserting the piercing punch into an inner hole of the billet to carry out flange upsetting, so that the spinning forming is completed gradually; and
step S4, forging forming of a shaft body:
inserting a special-shaped mandrel into the inner hole of the billet, pre-drawing a small end of the shaft body of the billet by using a v-shaped anvil, drawing out the shaft body of the billet in sequence, wherein a forging temperature range is 850-1250° C., the billet is drawn out in four sections which have respective dimensions of φ1170 mm×1110 mm, φ1090 mm×450 mm, φ990 mm×440 mm and φ900 mm×890 mm, and an overall forging ratio is ≥5.

Further, in step S1, the flat square billet made of the billet has dimensions of 900 mm×1400 mm×3000 mm.

Further, in step S1, the billet is held at the temperature of 1250° C. for 8-12 h.

Further, in working step 1 of step S2, a punched hole of the billet has a dimension of φ700 mm, and rolling dimensions are 1780 mm×1800 mm.

Further, in working step 2 of step S2, the punching block has dimensions of ¢1750 mmx φ750 mm×540 mm×R150 mm.

Further, in step S3, in a spinning forming process, when a temperature of the billet is lower than 850° C., the billet needs to be returned into the furnace at once for heat preservation, and then the spinning forming process is repeated.

Further, in step S3, the punching block has dimensions of 2600 mmx @1375 mm×550 mm×R320 mm.

In conclusion, the present invention has the following beneficial effects:
1. the piercing punch adopts a design of curved surface transition to allow the billet to have overall deformation, thereby realizing large deformation, fully crushing structures, improving coarse grains and effectively protecting the billet against folding and cracking in the punching process;
2. in the spinning forming process, the billet is subjected to special-shaped local die punching through the cooperation of the piercing punch and a die, so that dislocation and deformation of the inner hole can be effectively prevented in the upsetting process, and the problem of eccentricity can be effectively prevented and reduced;
3. in the spinning forming process, it is guaranteed that the billet is at a temperature of above 850° C. and has a good plastic deformation capacity so that both inner and outer sides of the billet can change according to the contours of the piercing punch and the die, thereby reducing the possibility of dislocation and deformation;
4. in the sectional drawing-out process, the problem of folding of the inner hole can be effectively solved, by controlling forging temperatures and forging ratios, the thickness reduction is controlled, and on the premise of protecting the inner holes against deformation, the coarse grain phenomenon is effectively improved; and
5. compared with a traditional forming method, the profiling forging near-net-shape forming method adopted for the inner hole of the billet has the advantages of substantially shortening a subsequent machining process without cutting the billet frequently and being capable of saving raw materials for manufacturing main shafts with the same model by 5 tons, shortening an overall manufacturing cycle of parts and reducing manufacturing costs.

### BRIEF DESCRIPTION OF THE DRAWINGS

FIG. 1 is a structural schematic view of a profiling billet.

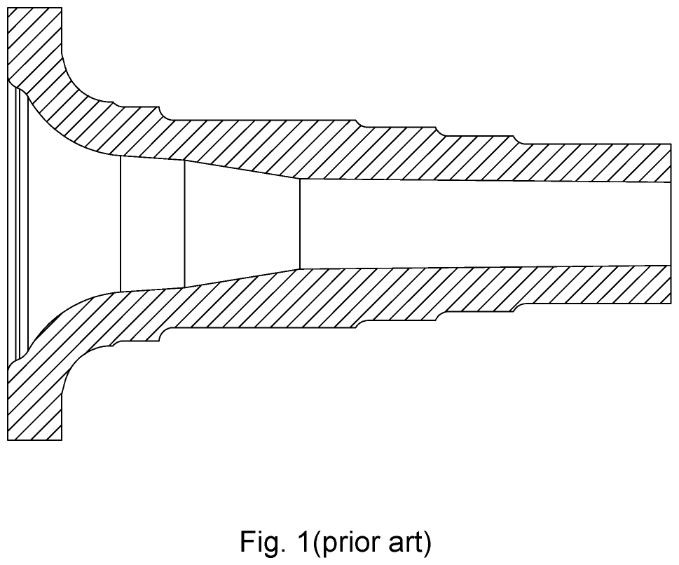

FIG. 2 is a structural schematic view of a traditional forging billet.

FIG. 3 is a schematic view of the state of a punching process.

FIG. 4 is a schematic view of the state of spinning forming.

FIG. 5 is a schematic view of the state of shaft body forming.

In figures, 1, piercing punch; 11, forming part I; 12, forming part II; 2, female die; 3, special-shaped mandrel.

### DETAILED DESCRIPTION OF EMBODIMENTS

To make the object, technical solutions, and advantages of the embodiments of the present invention clearer, an apparatus proposed in the present invention will be described in further detail below in conjunction with the accompanying drawings and the specific embodiments. The advantages and features of the present invention will be clearer according to the descriptions below.

### Embodiment 1

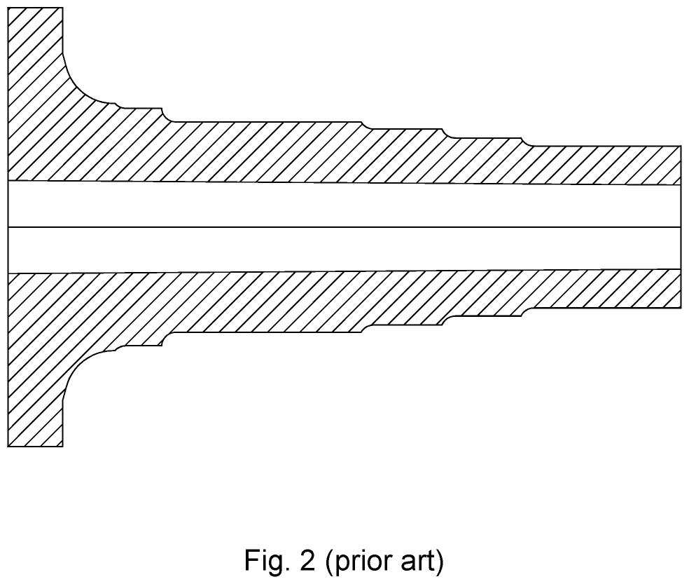

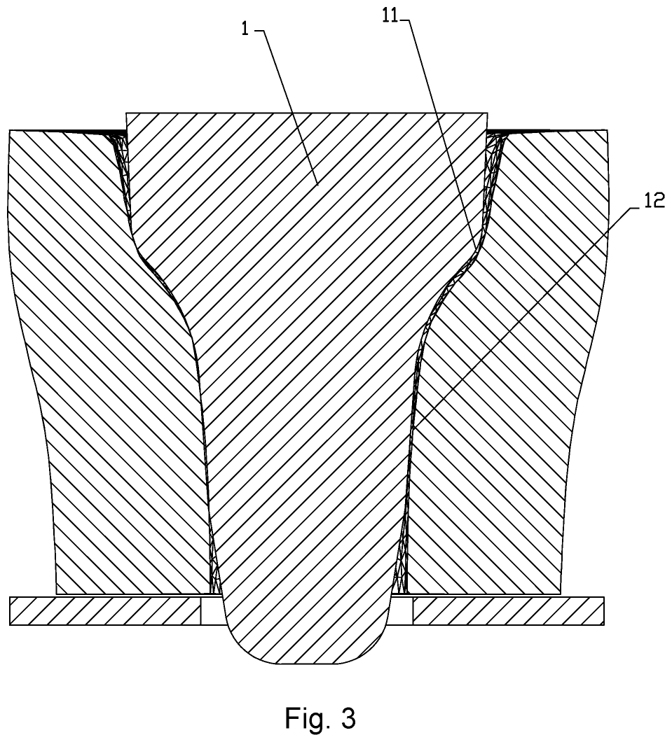

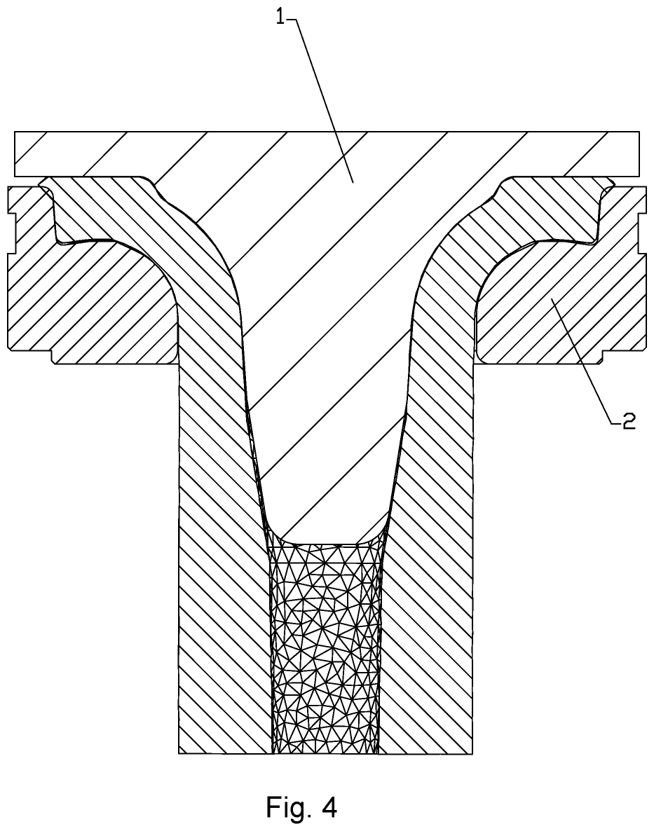

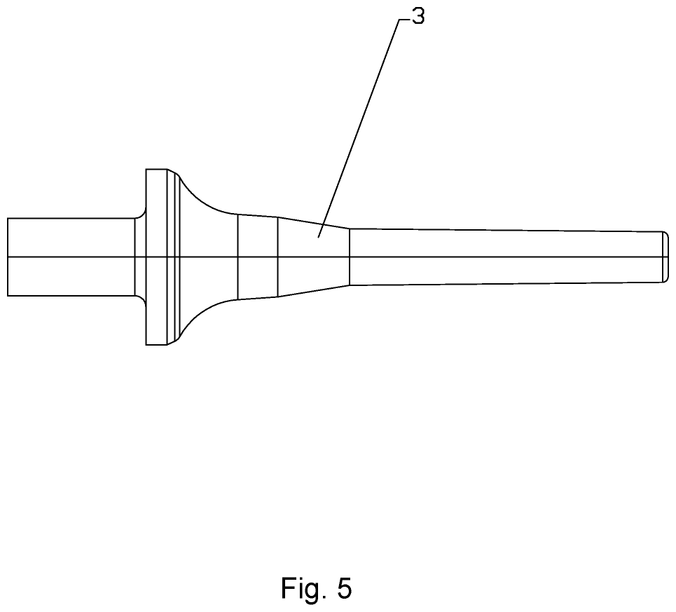

A compound profiling forging method for a large wind turbine main shaft, including the following steps:
step S1, carrying out first heat-up upsetting on a billet to make the billet into a flat square billet with dimensions of 900 mm×1400 mm×3000 mm, returning the billet into a furnace and holding a temperature at 1250° C. for 8 h.
step S2, preliminary stamping, including the following working steps:
working step 1: upsetting and drawing out the billet twice, and then carrying out punching and rolling on the billet, wherein as shown in FIG. 2, a punched hole of the billet has a dimension of φ700 mm, and rolling dimensions are φ1780 mm×1800 mm.
working step 2: as shown in FIG. 3, preparing a piercing punch 1 and a punching block with dimensions of φ1750 mm×φ750 mm×540 mm×R150 mm; the piercing punch 1 includes a forming part I 11 and a forming part II 12, the forming part II 12 is provided below the forming part I 11, a radius of the piercing punch 1 gradually decreases along a center axis from top to bottom, and a curved surface transits from the first forming part I 11 to the forming part II 12; putting the billet in the punching block, putting the piercing punch 1 into the hole of the billet, and operating an oil press to press the piercing punch 1 to be flush with the billet, wherein the forming part II 12 and the forming part I 11 are in contact with an inner wall of the inner hole of the billet, and under the action of external force from the punch, the inner wall of the inner hole of the billet changes correspondingly according to outlines of the forming part II 12 and the forming part I 11, so that the punching can be completed;
step S3, spinning forming:
heating the billet, holding a temperature at 850° C., putting the billet in the punching block with dimensions of φ2600 mm×41375 mm×550 mm×R320 mm, preparing a female die 2 and the piercing punch 1, mounting the female die 2 on the oil press, and as shown in FIG. 4, putting the billet at a center of rotation of the female die 2; as shown in FIG. 5, inserting the piercing punch 1 into the inner hole of the billet to carry out flange upsetting, so that the female die 2 extrudes an outer side of the billet, the piercing punch 1 carries out pressing forming on the inner hole of the billet, and the spinning forming is completed gradually; in the spinning forming process, the female die 2 is a special-shaped local punching die fixed to equipment, can effectively prevent dislocation and deformation of the inner hole in the upsetting process and can also effectively prevent and reduce the problem of eccentricity; and
when a temperature of the billet is lower than 850° C., the billet needs to be returned into the furnace at once for heat preservation, and the aforementioned process is repeated until the forming is completed, thereby ensuring that the billet has a sufficient plastic deformation capacity and a contour of the billet can depend on the contours of the female die 2 and the piercing punch 1; and
step S4, spinning forming:
as shown in FIG. 5, inserting a special-shaped mandrel 33 into the inner hole of the billet, pre-drawing a small end of a shaft body of the billet by using a v-shaped anvil, and drawing out the shaft body of the billet in sequence, wherein the billet is drawn out in four sections which have respective dimensions of @1170 mm×1110 mm, φ1090 mm×450 mm, φ990 mm×440 mm and φ900 mm×890 mm; a forging temperature of 850° C. ensures that a forging ratio of the inner hole of the billet is ≥5; and the forming process is divided into four stages, thereby avoiding eccentricity and folding of the inner hole in the transitional deformation process, ensuring that four sections of a forging piece with different radians are all evenly extruded and guaranteeing to complete a corresponding deformation process of the forging piece according to the contours of the special-shaped mandrel 33 and an inner cavity of the die; and after the forming is completed, proceeding to a follow-up working step.

### Embodiment 2

Steps different from those of Embodiment 1 include:
step S1, carrying out first heat-up upsetting on a billet to make the billet into a flat square billet with dimensions of 900 mm×1400 mm×3000 mm, returning the billet into a furnace and holding a temperature at 1250° C. for 10 h; and
step S4, spinning forming:
as shown in FIG. 5, inserting a special-shaped mandrel 33 into an inner hole of the billet, pre-drawing a small end of a shaft body of the billet by using a v-shaped anvil, and drawing out the shaft body of the billet in sequence, wherein the billet is drawn out in four sections which have respective dimensions of φ1170 mm×1110 mm, φ1090 mm×450 mm, @990 mm×440 mm and φ900 mm×890 mm; a forging temperature of 1140° C. ensures that a forging ratio of the inner hole of the billet is ≥5; and after the forming is completed, proceeding to a follow-up working step.

### Embodiment 3

Steps different from those of Embodiment 1 include:
step S1, carrying out first heat-up upsetting on a billet to make the billet into a flat square billet with dimensions of 900 mm×1400 mm×3000 mm, returning the billet into a furnace and holding a temperature at 1250° C. for 12 h; and
step S4, spinning forming:
as shown in FIG. 5, inserting a special-shaped mandrel 33 into an inner hole of the billet, pre-drawing a small end of a shaft body of the billet by using a v-shaped anvil, and drawing out the shaft body of the billet in sequence, wherein the billet is drawn out in four sections which have respective dimensions of φ1170 mm×1110 mm, φ1090 mm×450 mm, φ990 mm×440 mm and φ900 mm×890 mm; a forging temperature of 1230° C. ensures that a forging ratio of the inner hole of the billet is ≥5; and after the forming is completed, proceeding to a follow-up working step.

Performance tests of finished products:

Performance parameters of the finished products obtained from Embodiment 1 to Embodiment 3 see Table 1.

TABLE 1

| | Tensile | Yield | Elongation | Impact energy | |
|---|---|---|---|---|---|
| | strength | strength | after fracture | KU₂ | Hardness |
| Serial number | (MPa) | (MPa) | (%) | (J)−20° C. | HRC |
| Embodiment 1 | 913 | 770 | 20.5 | 150, 140, 155 | 280 |
| Embodiment 2 | 909 | 737 | 16.5 | 94, 97, 100 | 273 |
| Embodiment 3 | 898 | 722 | 16.0 | 95, 90, 96 | 269 |

The technical features of the above embodiments can be combined arbitrarily. To simplify the description, possible combinations of the technical features of the above embodiments are not completely described. However, as long as there is no contradiction between the combinations of these technical features, the combinations should be considered to fall within the scope of the present specification.

The above embodiments only express several embodiments of the present invention, and relatively specific and detailed descriptions thereof are provided. However, these embodiments cannot be understood as limitations to the scope of the patent of the present invention. It should be noted that those of ordinary skill in the art can make some modifications and improvements without departing from the idea of the present invention, and all these modifications and improvements should fall within the scope of protection of the present invention. Therefore, the scope of protection of the patent for the present invention should be subject to the claims.

What is claimed is:

1. A compound profiling forging method for a large wind turbine main shaft, comprising the following steps:
step S1, carrying out first heat-up upsetting on a billet to make the billet into a flat square billet, returning the billet into a furnace and holding a temperature at 1250° C.;
step S2, preliminary stamping, comprising the following working steps:
working step 1: upsetting and drawing out the billet twice, and carrying out punching and rolling on the billet; and
working step 2: preparing a piercing punch and a punching block, putting the billet in the punching block, putting the piercing punch into a hole of the billet, and operating an oil press to press the piercing punch to be flush with the billet, so that the punching is completed, wherein the piercing punch comprises a forming part I and a forming part II, the forming part II is provided below the forming part I, a radius of the piercing punch gradually decreases along a center axis from top to bottom, and a curved surface transits from the first forming part I to the forming part II;
step S3, spinning forming:
heating the billet, holding a temperature at 850° C., putting the billet in the punching block, preparing a female die and the piercing punch, mounting the female die on the oil press, inserting the piercing punch into an inner hole of the billet to carry out flange upsetting, so that the spinning forming is completed gradually; and
step S4, forging forming of a shaft body:
inserting a special-shaped mandrel into the inner hole of the billet, pre-drawing a small end of the shaft body of the billet by using a v-shaped anvil, drawing out the shaft body of the billet in sequence, wherein a forging temperature range is 850-1250° C., the billet is drawn out in four sections which have respective dimensions of φ1170 mm×1110 mm, φ1090 mm×450 mm, φ990 mm×440 mm and φ900 mm×890 mm, and an overall forging ratio is ≥5.

2. The compound profiling forging method for a large wind turbine main shaft according to claim 1, wherein in step S1, the flat square billet made of the billet has dimensions of 900 mm×1400 mm×3000 mm.

3. The compound profiling forging method for a large wind turbine main shaft according to claim 2, wherein in step S1, the billet is held at the temperature of 1250° C. for 8-12 h.

4. The compound profiling forging method for a large wind turbine main shaft according to claim 1, wherein in working step 1 of step S2, a punched hole of the billet has a dimension of φ700 mm, and rolling dimensions are φ1780 mm×1800 mm.

5. The compound profiling forging method for a large wind turbine main shaft according to claim 4, wherein in working step 2 of step S2, the punching block has dimensions of φ1750 mm×750 mm×540 mm×R150 mm.

6. The compound profiling forging method for a large wind turbine main shaft according to claim 1, wherein in step S3, in a spinning forming process, when a temperature of the billet is lower than 850° C., the billet needs to be returned into the furnace at once for heat preservation, and then the spinning forming process is repeated.

7. The compound profiling forging method for a large wind turbine main shaft according to claim 1, wherein in step S3, the punching block has dimensions of φ2600 mm×41375 mm×550 mm×R320 mm.
